(19) United States
(12) Patent Application Publication
(10) Pub. No.: US 2016/0140905 A1
(43) Pub. Date: May 19, 2016

(54) DISPLAY DEVICE AND METHOD FOR DRIVING THE SAME

(71) Applicant: SAMSUNG DISPLAY CO., LTD., Yongin-City (KR)

(72) Inventors: Myoung Hwan Yoo, Seoul (KR); Jang Doo Lee, Suwon-si (KR)

(21) Appl. No.: 14/709,400

(22) Filed: May 11, 2015

(30) Foreign Application Priority Data
Nov. 18, 2014 (KR) 10-2014-0161063

(51) Int. Cl. G09G 3/32

(52) U.S. Cl. CPC G09G 3/3275; G09G 2320/046; G09G 2320/0233

(57) ABSTRACT

A display device includes: a display panel including a plurality of pixels; and a controller configured to adjust a data signal applied to each of the plurality of pixels, and the plurality of pixels includes a plurality of pixel blocks, and the controller is configured to calculate a remaining lifespan of each of the plurality of pixel blocks and to adjust a maximum luminance of pixels between a first pixel block and a second pixel block based on a remaining lifespan of the first pixel block, by selecting the first pixel block and the second pixel block based on the remaining lifespan of each of the pixel blocks.

### CROSS-REFERENCE TO RELATED APPLICATION

This application claims priority to and the benefit of Korean Patent Application No. 10-2014-0161063 filed on Nov. 18, 2014 in the Korean Intellectual Property Office, the contents of which in its entirety are herein incorporated by reference.

### BACKGROUND

1. Field

The present invention relates to a display device and a method for driving the same.

2. Description of Related Art

Generally, an organic light emitting display device includes a pixel electrode, a common electrode, and organic films which are interposed between the pixel electrode and the common electrode. The organic films include at least an emitting layer (EML) and may further include a hole injecting layer (HIL), a hole transport layer (HTL), an electron transport layer (ETL), and an electron injecting layer (EIL). In such an organic light emitting device, holes and electrons, which are generated by an organic film, particularly, by a pixel electrode and a common electrode, are coupled, and when the energy level of the excitons, which are made by the coupling of holes and electrons, is changed from the excited state to the base state, light having a color corresponding to the changed energy level may be emitted.

Generally, the organic light emitting display device displays a desired image while supplying an electric current corresponding to gradation to an organic light emitting diode which is arranged for respective pixels. However, the organic light emitting diode is deteriorated as time passes, and thus an image of a desired luminance may not be displayed. In practice, if an organic light emitting diode is deteriorated, light of a low luminance is gradually generated according to the same signal. In particular, such a problem may occur in an area where a logo is displayed, and thus the lifespan of the area where the logo is displayed is reduced, thereby generating a difference in luminance according to the display area.

### SUMMARY

Embodiments of the present invention provide a display device and a method of driving the same which can reduce a luminance difference between areas of a panel.

In accordance with an aspect of the present invention, a display device includes: a display panel including a plurality of pixels; and a controller configured to adjust a data signal applied to each of the plurality of pixels, and the plurality of pixels includes a plurality of pixel blocks, and the controller is configured to calculate a remaining lifespan of each of the plurality of pixel blocks and to adjust a maximum luminance of pixels between a first pixel block and a second pixel block based on a remaining lifespan of the first pixel block, by selecting the first pixel block and the second pixel block based on the remaining lifespan of each of the pixel blocks.

The first pixel block may have a shortest remaining lifespan among the pixel blocks, and the second pixel block may have a longest remaining lifespan among the pixel blocks.

The display panel may include: a first pixel area including the first pixel block; and a second pixel area including the second pixel block,

The respective maximum luminances of the pixel blocks in the first pixel area may be substantially the same, and the respective maximum luminances of the pixel blocks in the second pixel area may be substantially the same.

The maximum luminance of each of the pixel blocks may increase at substantially the same rate from the first pixel area to the second pixel area on the basis of the remaining lifespan of the first pixel block.

When the remaining lifespan of the first pixel block becomes shorter than a reference lifespan, the maximum luminance of the second pixel area may be reduced by a difference between the rate of the remaining lifespan of the first pixel block and the rate of the reference lifespan.

The maximum luminance of each of the pixel blocks between the first pixel area and the second pixel area may be reduced by a difference between the rate of the remaining lifespan of the first pixel block and the rate of the reference lifespan.

The remaining lifespan may be measured based on accumulation of an amount of data by each of the pixel blocks.

The controller may include: a lifespan calculator configured to measure a lifespan of each pixel block; a block selector configured to select the first pixel block having a shortest remaining lifespan among the pixel blocks and the second pixel block having a longest remaining lifespan among the pixel blocks; and a data adjuster configured to adjust the maximum luminances of the first pixel block, the second pixel block, and each pixel block between the first pixel block and the second pixel block.

The data adjuster may be configured to adjust a data signal applied to each pixel block between the first pixel block and the second pixel block so that the maximum luminance of each of the pixel blocks increases at substantially the same rate from the first pixel block to the second pixel block on the basis of the remaining lifespan of the first pixel block.

The data adjuster may further include an average luminance calculator and the average luminance calculator may be configured to measure the average luminance of each of the pixel blocks.

In accordance with another aspect of the present invention, a display device includes: a display panel including a plurality of pixels; and a controller configured to adjust a data signal applied to each of the plurality of pixels, and the plurality of pixels includes a plurality of pixel blocks, and the controller is configured to analyze the data signal applied to each of the pixel blocks so as to select a logo part and a central part, and is configured to adjust a maximum luminance of pixels between the logo part and the central part on the basis of a remaining lifespan of the logo part.

The logo part may have a substantially constant change rate of an amount of data of the data signal applied to each of the pixel blocks and may have a shortest remaining lifespan, and the central part may have a non-constant change rate of the amount of data of the data signal applied to each of the pixel blocks and may have a longest remaining lifespan.

The display panel may include: a first pixel area including the logo part; and a second pixel area including the central part, and respective maximum luminances of the pixel blocks in the first pixel area may be substantially the same, and the respective maximum luminances of the pixel blocks in the second pixel area may be substantially the same.

The maximum luminance of each of the pixel blocks may increase at substantially the same rate from the first pixel area to the second pixel area on the basis of the remaining lifespan of the logo part.

The maximum luminance of each of the pixel blocks between the first pixel area and the second pixel area may be reduced by a difference between the rate of the remaining lifespan of the logo part and a reference lifespan.

In accordance with other aspects of the present invention, a method of driving a display device includes: determining a remaining lifespan of each of a plurality of pixel blocks by analyzing an amount of data of an image signal applied to the plurality of pixel blocks; selecting a first pixel block and a second pixel block from among the plurality of pixel blocks based on the determined remaining lifespan of each of the pixel blocks; and adjusting a maximum luminance of a pixel block between the first pixel block and the second pixel block on the basis of the remaining lifespan of the first pixel block.

The first pixel block may have a shortest remaining lifespan among the pixel blocks, and the second pixel block may have a longest remaining lifespan among the pixel blocks.

The method may further include: comparing the remaining lifespan of the first pixel block with a reference lifespan.

The method may further include: not adjusting the maximum luminance of the second pixel block when the remaining lifespan of the first pixel block is the reference lifespan or larger; and adjusting the maximum luminance of the second pixel block when the remaining lifespan of the first pixel block is less than the reference lifespan.

The first pixel block may have a substantially constant change rate of the amount of data of a data signal applied to each of the pixel blocks and may have a shortest remaining lifespan, and the second pixel block may have a non-constant change rate of the amount of data of a data signal applied to each of the pixel blocks and may have a longest remaining lifespan.

### BRIEF DESCRIPTION OF THE DRAWINGS

The above and other features and aspects of the present invention will become more apparent by describing in detail example embodiments thereof with reference to the attached drawings in which:

FIG. 1 is a block diagram of a display device according to an embodiment of the present invention;

FIG. 2 is an equivalent circuit diagram of one pixel of FIG. 1;

FIG. 3 is a block diagram of a control unit (or controller) of a display device according to an embodiment of the present invention;

FIG. 4 is a block diagram of a data adjustment unit (or data adjuster) of a display device according to an embodiment of the present invention;

FIG. 5 is a flowchart illustrating a method of driving a display device according to an embodiment of the present invention;

FIG. 6 illustrates positions of a first pixel block and a second pixel block of a display device according to an embodiment of the present invention;

FIG. 7 is a graph illustrating a change of luminance between areas of a display device according to an embodiment of the present invention;

FIG. 8 illustrates a luminance distribution of areas when the lifespan of a logo part of a display device is longer than a reference lifespan according to an embodiment of the present invention;

FIG. 9 illustrates a size of luminance of each area of FIG. 8;

FIG. 10 illustrates luminance distribution when the lifespan of a logo part of a display device is shorter than a reference lifespan according to an embodiment of the present invention;

FIG. 11 illustrates a size of luminance of each area of FIG. 10; and

FIG. 12 is a flowchart illustrating a method of driving a display device according to another embodiment of the present invention.

### DETAILED DESCRIPTION

The aspects and features of the present invention and methods for achieving the aspects and features will be apparent by referring to example embodiments to be described in more detail with reference to the accompanying drawings. However, the present invention may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The display device, controller, data driver, scan driver, light emission driver, voltage generator, display panel, and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or the like, or formed on a same substrate(s) as the devices. Further, the various components of these devices may be a process or thread, running on one or more processors, in one or more computing devices, executing computer program instructions and interacting with other system components for performing the various functionalities described herein. The computer program instructions may be stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirt and scope of the exemplary embodiments of the present invention.

Expressions such as “at least one of,” when preceding a list of elements, modify the entire list of elements and do not modify the individual elements of the list. Further, the use of “may” when describing embodiments of the present invention refers to “one or more embodiments of the present invention.”

Hereinafter, embodiments of the present invention will be described with reference to the attached drawings.

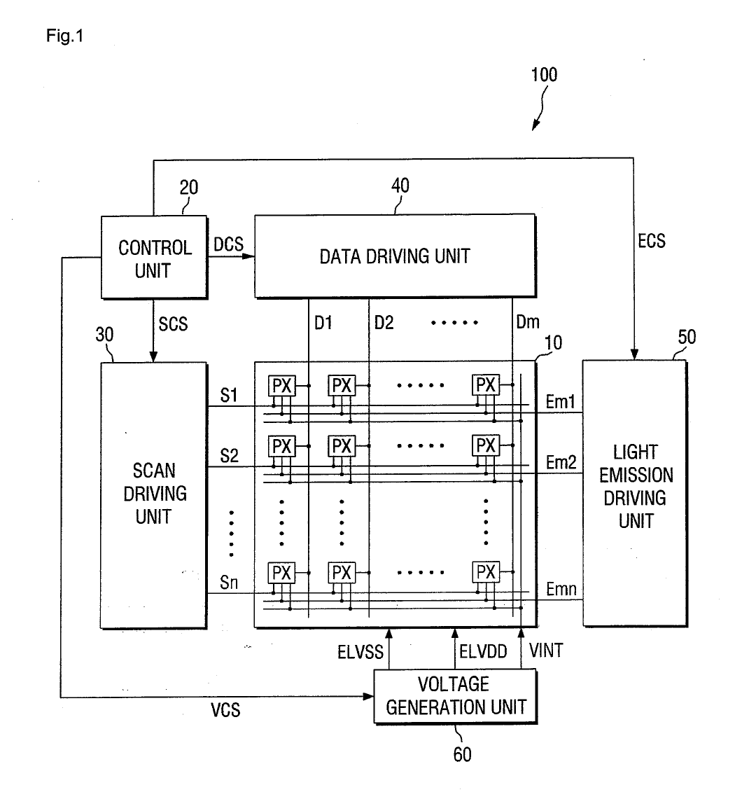

FIG. 1 is a block diagram of a display device according to an embodiment of the present invention. Referring to FIG. 1, a display device 100 includes a display panel 10, a control unit (or a controller) 20, a scan driving unit (or a scan driver) 30, a data driving unit (or a data driver) 40, a light emission driving unit (or a light emission driver) 50, and a voltage generation unit (or a voltage generator) 60.

The display panel 10 may include a plurality of pixels PX and wires for transmitting signals to the plurality of pixels PX. The plurality of pixels PX may be arranged in a matrix form. Each of the plurality of pixels PX may emit light in one of red, green, and blue colors. The light emission of the plurality of pixels PX may be controlled by first to nth scan signals S1, S2, . . . , Sn, first to mth data signals D1, D2, . . . , Dm, and first to nth light emission signals EM1, EM1, . . . , EMn which are supplied from the outside of the display panel 10. The first to nth scan signals S1, S2, . . . , Sn may control whether or not the plurality of respective pixels PX is to receive first to mth data signals D1, D2, . . . , Dm. First to mth data signals D1, D2, . . . , Dm may contain information on luminance of light emitted by the plurality of respective pixels PX. The first to nth light emission signals EM1, EM2, . . . , EMn may control whether or not the plurality of respective pixels PX are to emit light (or be light-emitted).

Wires may contain first to nth scan signals S1, S2, . . . , Sn, first to mth data signals D1, D2, . . . , Dm, first to nth light emission signals EM1, EM1, . . . , EMn, and wires for transmitting an initialization voltage VINT. Wires for transmitting first to nth scan signals S1, S2, . . . , Sn and first to nth light emission signals EM1, EM2, . . . , EMn may be arranged to be extended in the horizontal direction of the plurality of pixels PX. The wires for transmitting the first to mth data signals D1, D2, . . . , Dm may be arranged to be extended in the vertical direction of the plurality of pixels PX. The wires for transmitting the initialization voltage VINT may be arranged to be extended in the horizontal direction of the plurality of pixels PX. The wires for transmitting the initialization voltage VINT may be formed in a zigzag form.

The display panel 10 may include a plurality of pixels PX. The plurality of pixels PX may be defined as a plurality of pixel blocks. The luminance of the respective pixel blocks may be adjusted according to the lifespan of the pixel blocks, which will be described later.

The control unit 20 may receive image data from an external source (or side) and accordingly generate a scan driving unit control signal (or scan driver control signal) SCS for controlling the scan driving unit 30, a data driving unit control signal (or data driver control signal) DCS for controlling the data driving unit 40, and a light emission driving unit control signal (or light emission driver control signal) ECS for controlling the light emission driving unit 50.

The scan driving unit 30 may receive the scan driving unit control signal SCS and accordingly generate first to nth scan signals, and may provide the first to nth scan signals S1, S2, . . . , Sn to the display panel 10 through a plurality of scan lines.

The data driving unit 40 may receive the data driving unit control signal DCS and accordingly generate first to mth data driving unit signals D1, D2, . . . , Dm, and may provide first to mth data signals D1, D2, . . . , Dm to the display panel 10 through a plurality of data lines.

The light emission driving unit 50 may receive the light emission driving unit control signal ECS and accordingly generate first to nth light emission signals EM1, EM2, . . . , EMn, and may provide the first to nth light emission signals EM1, EM2, . . . , EMn to the display panel 10 through a plurality of light emission control lines.

The voltage generation unit (or power generation unit, voltage generator, or power generator) 60 may generate an initialization voltage VINT, a first power voltage ELVDD, and a second power voltage ELVSS so as to be provided to the display panel 10. In the present specification, it is described in an embodiment that the initialization voltage VINT, the first power voltage ELVDD, and the second power voltage ELVSS are fixed, but embodiments are not limited thereto. The voltage generation unit (or power generation unit) 60 may be controlled so that the initialization voltage VINT, the first power voltage ELVDD, and the second power voltage ELVSS may be changed.

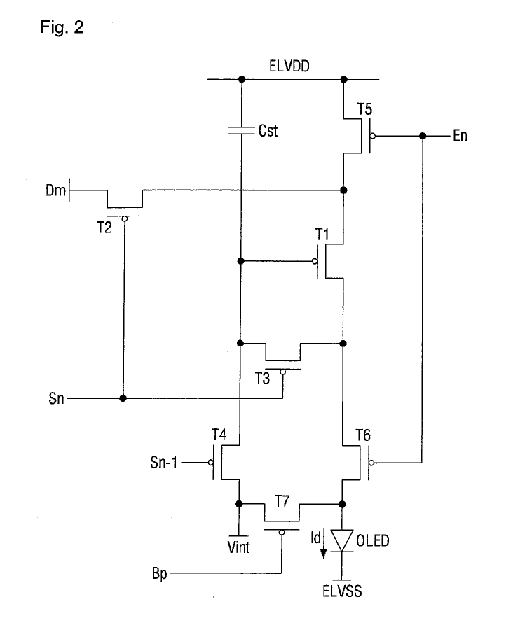

FIG. 2 is an equivalent circuit diagram of one pixel of FIG. 1. Referring to FIG. 2, one pixel of an organic light emitting display device according to an embodiment of the present invention includes a plurality of thin film transistors T1, T2, T3, T4, T5, T6, and T7, a storage capacitor Cst, and an organic light emitting diode OLED.

The thin film transistor may include a first thin film transistor (e.g., driving thin film transistor) T1, a second thin film transistor (e.g., switching thin film transistor) T2, a third thin film transistor T3, a fourth thin film transistor T4, a fifth thin film transistor T5, a sixth thin film transistor T6, and a seventh thin film transistor T7.

The plurality of signals may include one or more of a scan signal applied to a scan line Sn, a previous scan signal applied to a previous scan line Sn-1, a light emission control signal applied to a light emission control line En, a data signal applied to a data line Dm, a first power voltage ELVDD, a second power voltage ELVSS, an initialization voltage Vint, and a black voltage signal applied to a signal line Bp.

The gate electrode of the first thin film transistor T1 may be connected to one end of the storage capacitor Cst, the source electrode of the first thin film transistor T1 may be connected to the first power voltage ELVDD via the fifth thin film transistor T5, and the drain electrode of the first thin film transistor T1 may be electrically connected to the anode of the organic light emitting diode OLED via the sixth thin film transistor T6. The first thin film transistor T1 may receive a data signal D[n] according to the switching operation of the second thin film transistor T2 so as to supply a driving current to the organic light emitting diode OLED.

The gate electrode of the second thin film transistor T2 may receive a scan signal, the source electrode of the second thin film transistor T2 may receive a data signal, and the drain electrode of the second thin film transistor may be connected to the source electrode of the first thin film transistor T1 and may receive a first power voltage via the fifth thin film transistor T5. Such a second thin film transistor T2 may be turned on according to the scan signal so as to perform a switching operation which transmits the data signal to the source electrode of the first thin film transistor T1.

The gate electrode of the third thin film transistor T3 may receive a scan signal, the source electrode of the third thin film transistor may be connected to the drain electrode of the first thin film transistor T1, and may be connected to the anode of the organic light emitting diode OLED via the sixth thin film transistor T6, and the drain electrode of the third thin film transistor T3 may be connected to one end of the storage capacitor Cst, the drain electrode of the fourth thin film transistor T4, and the gate electrode of the first thin film transistor T1. The third thin film transistor T3 may be turned on according to the scan signal so as to connect the gate electrode of the first thin film transistor T1 with the drain electrode D1 of the first thin film transistor T1 so as to diode-connect the first thin film transistor T1.

The gate electrode of the fourth thin film transistor T4 may receive a previous scan signal, the source electrode of the fourth thin film transistor T4 may receive an initialization voltage Vint, and the drain electrode of the fourth thin film transistor T4 may be connected to one end of the storage capacitor Cst, the drain electrode of the third thin film transistor T3, and the gate electrode of the first thin film transistor T1. Such a fourth thin film transistor T4 may be turned on according to the previous scan signal so as to transmit the initialization voltage Vint to the gate electrode of the first thin film transistor T1 so as to initialize the voltage of the gate electrode of the thin film transistor T1.

The gate electrode of the fifth thin film transistor T5 may receive a light emission control signal, the source electrode of the fifth thin film transistor T5 may receive a first power voltage ELVDD, and the drain electrode of the fifth thin film transistor T5 may be connected to the source electrode of the first thin film transistor T1 and the drain electrode of the second thin film transistor T2.

The gate electrode of the sixth thin film transistor T6 may receive a light emission control signal, the source electrode of the sixth thin film transistor T6 may be connected to the drain electrode of the first thin film transistor T1 and the source electrode of the third thin film transistor, and the drain electrode of the sixth thin film transistor may be electrically connected to the anode of the organic light emitting diode OLED and the drain electrode (or terminal) of the seventh thin film transistor T7. The fifth thin film transistor T5 and the sixth thin film transistor T6 may be simultaneously turned on according to the light emission control signal En[n] so that the first power voltage ELVDD is transmitted to the organic light emitting diode OLED so that the driving current may flow in the OLED.

The gate electrode of the seventh thin film transistor T7 may receive a black voltage signal, the source electrode of the seventh thin film transistor T7 may receive an initialization voltage Vint, and the drain electrode of the seventh thin film transistor T7 may be connected to the anode of the organic light emitting diode OLED and the drain terminal of the sixth thin film transistor T6. The seventh thin film transistor T7 may be turned on according to the black voltage signal GB[n] so as to transmit the initialization voltage Vint to the anode of the organic light emitting diode OLED so as to perform an operation of applying a black voltage.

The other end of the storage capacitor Cst may be connected to the first power voltage ELVDD, and the cathode of the organic light emitting diode may be connected to the second power voltage ELVSS. As such, the organic light emitting diode OLED may receive driving current from the first thin film transistor T1 so as to emit light, thereby displaying an image.

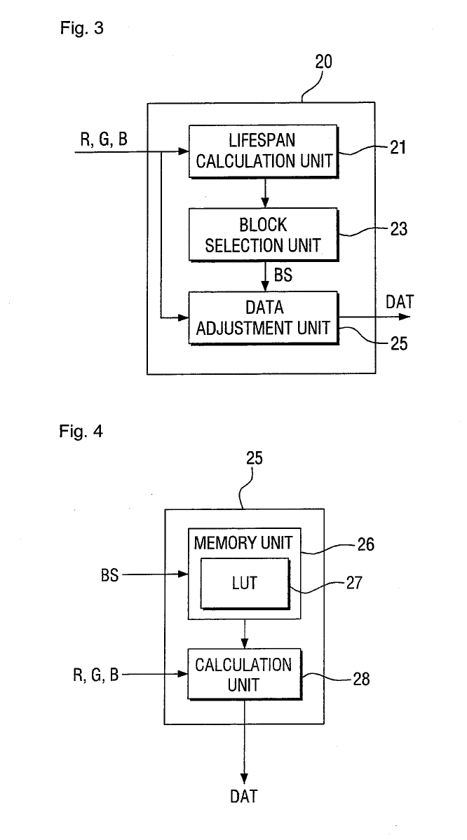

FIG. 3 is a block diagram of a control unit (or controller) of a display device according to an embodiment of the present invention. Referring to FIG. 3, the control unit 20 may receive an input image signal R, G, B from an external source (or side) so as to provide a data signal DAT, and may include a lifespan calculation unit (or a lifespan calculator) 21, a block selection unit (or a block selector) 23, and a data adjustment unit (or a data adjuster) 25.

The lifespan calculation unit 21 may measure the size of the input image signal R, G, B provided to each pixel at each point of time and measure the accumulated sum of the amount of data used in each pixel. The lifespan of each pixel may be reduced in proportion to the used amount of data, and thus the remaining lifespan of each pixel may be measured by measuring the amount of data used. The amount of data used in the pixels which continually emit light corresponding to the data signal of high gradation is greater than the amount of data used in the pixels which continually emit light corresponding to the data signal of low gradation, and thus the lifespan of pixels which continually emit light corresponding to the data signal of the high gradation gets shorter than the lifespan of pixels which continually emit light corresponding to the data signal of the low gradation. Hence, the lifespan calculation unit 21 may accumulate the sizes of the data signals DAT which are used by respective pixels so as to provide the remaining lifespans of the respective pixels to the block selection unit 23, which is to be described later. However, here, the method of measuring the lifespans of respective pixels is not limited thereto. A method of measuring the deteriorated level of individual pixels by sensing the amount of emitted light by using a sensing device, etc. may also be used.

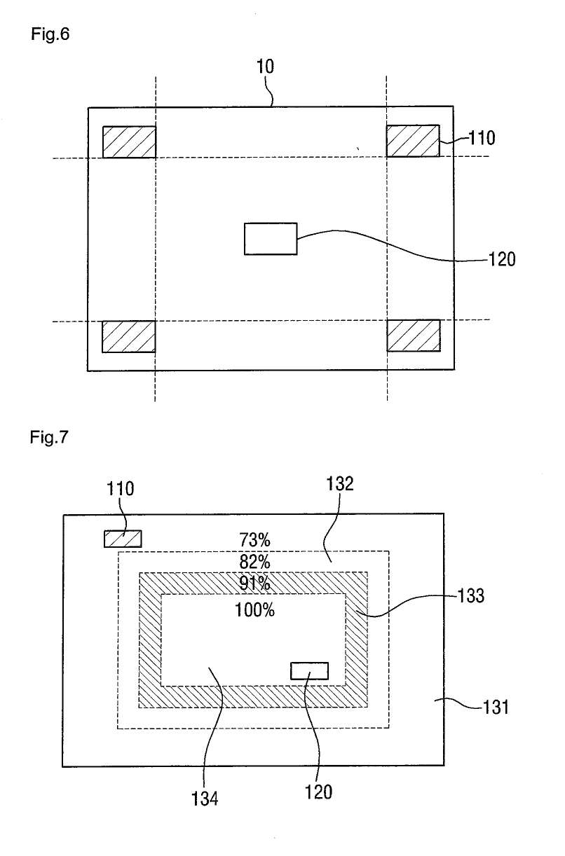

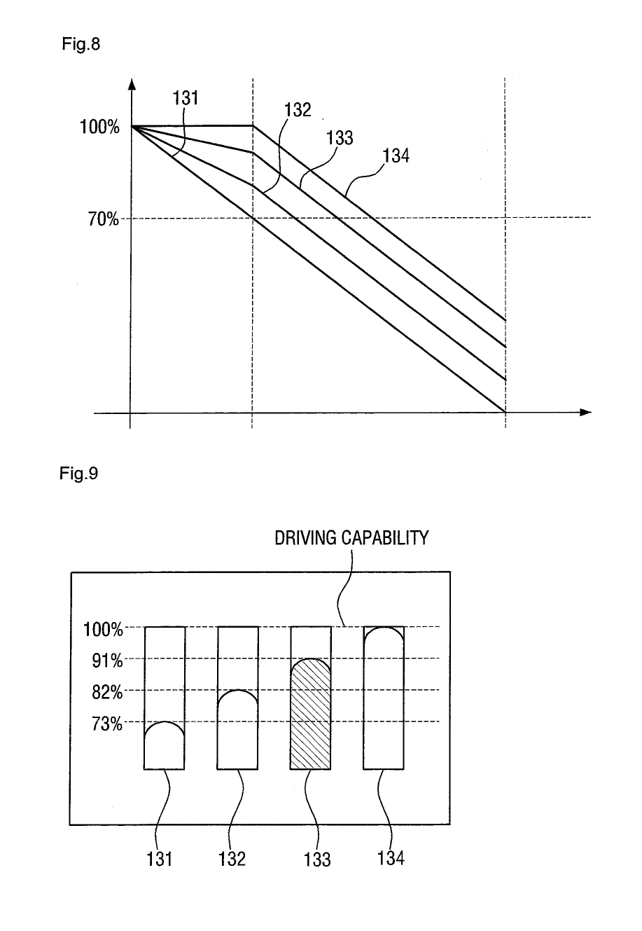

The block selection unit 23 may select a first pixel block (e.g., reference numeral 110 of FIG. 6) including the pixel having the shortest lifespan and may select a second pixel block (e.g., reference numeral 120 of FIG. 6) including a pixel having the longest lifespan by utilizing the remaining lifespans of the individual pixels provided by the lifespan calculation unit 21. The block selection unit 23 may provide a block selection signal BS including location information and lifespan information of the selected first pixel block 110 and second pixel block 120 to the data adjustment unit 25. Further, the block selection unit 23 may divide the display panel 100 into a plurality of areas. The plurality of areas may be divided into a first pixel area (e.g., reference numeral 131 of FIG. 8) including the first pixel block 110 and a second pixel area (e.g., reference numeral 134 of FIG. 8) including the second pixel block 120.

The data adjustment unit 25 may receive a block selection signal BS including location information and lifespan information and adjust the luminance of the pixel block which is located between the first pixel block 110 and the second pixel block 120 on the basis of the lifespan of the first pixel block 110. The remaining lifespan of the first pixel block 110 is different from the remaining lifespan of the second pixel block 120, and thus the maximum luminance of the first pixel block 110 and the maximum luminance of the second pixel block 120 may be different for the same data voltage which is supplied to the first pixel block 110 and the second pixel block 120. The maximum luminance of each pixel block may be proportional to the remaining lifespan of each pixel block. Hence, the luminance of the blocks, which are located between the first pixel block 110 and the second pixel block 120, may be gradually changed (e.g., set to be gradually changed) in consideration of the lifespan of the first pixel block 110. In the present embodiment, the area, which is located between the first pixel area 131 and the second pixel area 134, is divided into three pixel areas to describe the method of adjusting luminance, but the method is not limited thereto. The area, which is located between the first pixel area 131 and the second pixel area 134, is divided into a plurality of pixel areas so as to gradually change the luminance between the first pixel area 131 and the second pixel area 134.

The control unit 20 may further include an average luminance calculation unit (not shown), and the average luminance calculation unit may measure the average luminance of each of the pixel blocks.

The data adjustment unit 25 may output data signals DAT corresponding to the first pixel block 110, the luminance-adjusted second pixel block 120, and blocks which are located between the luminance-adjusted first pixel block 110 and second pixel block 120. Hereinafter, the structure of the data adjustment unit 25 will be described in detail with reference to FIG. 4.

FIG. 4 is a block diagram of a data adjustment unit (or data adjuster) of a display device according to an embodiment of the present invention. Referring to FIG. 4, the data adjustment unit 25 includes a memory unit (or a memory) 26 and a calculation unit (or a calculator) 28.

The memory unit 26 may receive a block selection signal BS and may include a look-up table 27 including luminance information corresponding to location information and lifespan information of the first pixel block 110 and the second pixel block 120.

The look-up table 27 may include luminance information of the first pixel area 131 which has been adjusted in the same manner as that of the maximum luminance of the first pixel block, luminance information of the second pixel area 134 which has been adjusted in the same manner as that of the second pixel block, and adjusted luminance information of the area (e.g., reference numerals 132 and 133 of FIG. 8) which is located between the first pixel area 131 and the second pixel area 134.

The calculation unit 28 may analyze the input image signal R, G, B which is provided from an external source (or side) so as to adjust the input image signal R, G, B according to the maximum luminance of the pixel areas 131 to 134. The calculation unit 28 may reflect luminance information for respective areas which have been provided from the look-up table 27 so as to adjust luminance of the input image signal R, G, B, and provide the adjusted data signal DAT to the data driving unit 30.

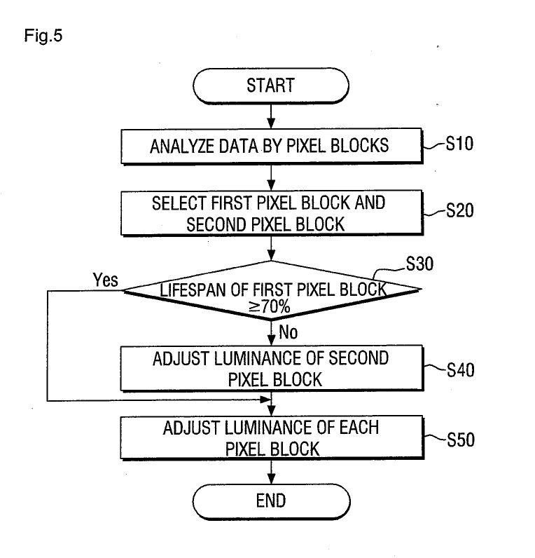

FIG. 5 is a flowchart illustrating a method of driving a display device according to an embodiment of the present invention. Referring to FIG. 5, according to the method of driving the display device according to the present embodiment, the lifespan calculation unit 21 may perform (or include) the operation S10 of analyzing data used in the pixel blocks. For example, the lifespan calculation unit 21 may measure the size of the input image signal which is applied for each pixel block and the accumulated sum of the amount of data used in individual pixel blocks. Further, the block selection unit 23 may perform (or include) the operation S20 of selecting the first pixel block (e.g., reference numeral 110 of FIG. 6) including a pixel having the shortest lifespan and selecting the second pixel block (e.g., reference numeral 120 of FIG. 6) including a pixel having the longest lifespan by utilizing the remaining lifespan of each individual pixel which is provided by the lifespan calculation unit 21. Further, the operation S30 of comparing whether or not the lifespan of the first pixel block is greater than or equal to a reference value (e.g., 70%) may be included. For example, the operation 30 may determine whether or not the measured remaining lifespan rate of the first pixel block 110 has been reduced by a rate (e.g., a preset rate (e.g., 30% or more). If the remaining lifespan of the first pixel block 110 has been reduced by the rate (e.g., the preset rate), the maximum luminance of the second pixel block may be adjusted by as much as the value which is obtained by adding the rate (e.g., the preset rate) to the remaining lifespan rate of the first pixel block 110 (S40). However, if the remaining lifespan of the first pixel block 110 has been reduced by less than the rate (e.g., the preset rate), the maximum luminance of the second pixel block 120 may be retained without adjustment. Finally, the maximum luminance of the pixel block, which is located between the first pixel block 110 and the second pixel block 120, may be gradually reduced (e.g., set to be gradually reduced) in order for the difference in the maximum luminance between the first pixel block 110 and the second pixel block 120 to be less noticeable (or not to be clearly recognized) (S50). As the maximum luminance of each pixel area is gradually reduced from the second pixel area 134 including the second pixel block 120 to the first pixel area 131 including the first pixel block 110, the difference in luminance for respective areas may be less noticeable (or may not be clearly recognized).

FIG. 6 illustrates positions of a first pixel block and a second pixel block of a display device according to an embodiment of the present invention. Referring to FIG. 6, a first pixel block 110 and a second pixel block 120 may be formed on the display panel 10.

In one embodiment, the data of high luminance is continually provided to the first pixel block 110, and thus the lifespan of the first pixel block 110 is shorter than the lifespans of other pixel blocks. Generally, the first pixel block 110 may be formed at a position where the logo of each channel is arranged. Positions where logos of respective channels are displayed may be different, but the logos may be generally formed at the edges of the display panel 10.

Data of various luminances are provided in the second pixel block 120, and thus the second pixel block 120 may be formed at the central part of the display panel 10. The second pixel block 120 may be positioned variously by channels and may not be formed at the central part of the panel.

FIG. 7 is a graph illustrating a change of luminance between areas of a display device according to an embodiment of the present invention, and FIG. 8 illustrates a luminance distribution of areas when the lifespan of a logo part of a display device is longer than the reference lifespan according to an embodiment of the present invention, and FIG. 9 illustrates a size of luminance of each area of FIG. 8.

Referring to FIGS. 7 and 8, the display panel 10 may be divided into four pixel areas. That is, the display panel 10 may be divided into a first pixel area 131 including a first pixel block 110, a second pixel area 134 including a second pixel block 120, a third pixel area 132 and a fourth pixel area 133 which are formed between (or on) the first pixel area 131 and the second pixel area 134.

The difference with the remaining lifespan rate of the second pixel block 120 may be determined based on the remaining lifespan rate of the first pixel block 110. The difference between the remaining lifespan rate of the first pixel block 110 and the remaining lifespan rate of the second pixel block 120 may be apportioned or divided according to a number which is greater by 1 than the number of the pixel areas which have been formed between the first pixel block 110 and the second block 120. For example, if the remaining lifespan of the first pixel block 110 is 73% and the remaining lifespan of the second pixel block 120 is 100%, the third pixel area 132 and the fourth pixel area 133 may respectively have the maximum luminances of 82% and 91%.

The difference between the remaining lifespan rates of the first pixel block 110 and the second pixel block 120 may be calculated, and the difference may be apportioned or divided according to a number which is greater by one than the number of pixel areas which have been formed between the first pixel block 110 and the second pixel block 120 so as to adjust the maximum luminance of the pixel area until the remaining lifespan rate of the first pixel block 110 does not reach a reference rate (e.g., 70%). When the remaining lifespan rate of the first pixel block 110 reaches the reference rate, the rates of the maximum luminances of the pixel areas, which have been formed between the first pixel block 110 and the second pixel block 120, are reduced at a time by the difference between the remaining lifespan rate of the first pixel block 110 and the reference rate.

Hence, the gradient of the maximum luminance rate of the third pixel area 132 and the fourth pixel area 133 until the remaining lifespan rate of the first pixel block 110 reaches the reference rate may be different from the gradient (or rate) of the maximum luminance rate of the third pixel area 132 and the fourth pixel area 133 after the remaining lifespan rate of the first pixel block 110 reaches the reference rate.

In the present embodiment, an example where the third pixel area 132 and the fourth pixel area 133 are formed between the first pixel area 131 and the second pixel area 134 is illustrated, but embodiments are not limited thereto and it is possible to reduce or prevent noticeability (or clear recognition) of the luminance difference between areas including a plurality of pixel areas.

Further, in the present embodiment, it is assumed that the lifespan of the second pixel block 120 is not reduced while the lifespan of the first pixel block 110 is reduced, but embodiments are not limited thereto. The lifespan of the second pixel block 120 may also be reduced, and the maximum luminance rate of each pixel area may be adjusted by equally adjusting the rate difference of the remaining lifespan between the first pixel block 110 and the second pixel block 120.

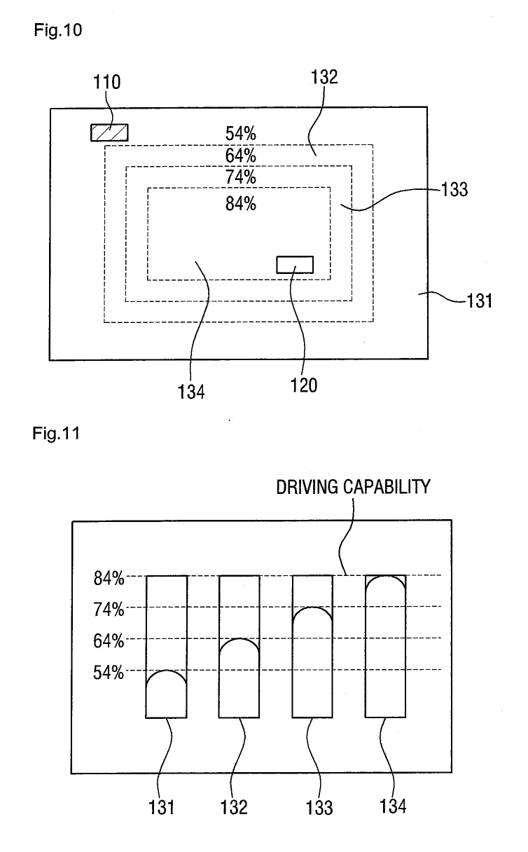

FIG. 10 illustrates luminance distribution when the lifespan (or remaining lifespan) of a logo part of a display device is shorter than a reference lifespan according to an embodiment of the present invention, and FIG. 11 illustrates a size of luminance of each area of FIG. 10.

When the remaining lifespan rate of the first pixel block 110 becomes lower than the reference rate, the rates of the maximum luminances of the pixel areas, which have been formed between the first pixel block 110 and the second pixel block 120, are reduced at a time by the difference between the remaining lifespan rate of the first pixel block 110 and the reference rate.

For example, when the remaining lifespan rate (e.g., 54%) of the first pixel rate 110 becomes lower than the reference rate (e.g., 70%), the maximum luminance rates of other pixel areas 132, 133, and 133 may be further adjusted by the difference between the remaining lifespan rate of the first pixel block 110 and the reference rate. Hence, the maximum luminance rate of the first pixel area may be adjusted to 54%. Further, the maximum luminance rate of the second pixel area may be adjusted to 64% which is obtained by deducting the difference between the remaining lifespan rate of the first pixel block and the reference rate from 80% which is the maximum luminance rate of each existing pixel area. Further, the maximum luminance rate of the third pixel area may be adjusted to the maximum luminance rate of 74% which is obtained by deducting the difference between the remaining lifespan rate of the first pixel block 110 and the reference rate from 90% which is the maximum luminance rate of each existing pixel area. Finally, the maximum luminance rate of the fourth pixel area may be adjusted to the maximum luminance rate of 84% which is obtained by deducting the difference between the remaining lifespan rate of the first pixel block 110 and the reference rate from 100% which is the maximum luminance rate of each existing pixel area.

Hence, the gradients of the maximum luminance rates of the first pixel area 131, the second pixel area 134, the third pixel area 132, the fourth pixel area 133 after the remaining lifespan rate of the first pixel block 110 reaches the reference rate may be maintained substantially constant and have substantially the same size.

In the present embodiment, an example where the third pixel area 132 and the fourth pixel area 133 are formed between the first pixel area 131 and the second pixel area 134 is illustrated, but embodiments are not limited thereto. It may be possible to reduce or prevent noticeability (or clear recognition) of the luminance difference between areas including a plurality of pixel areas.

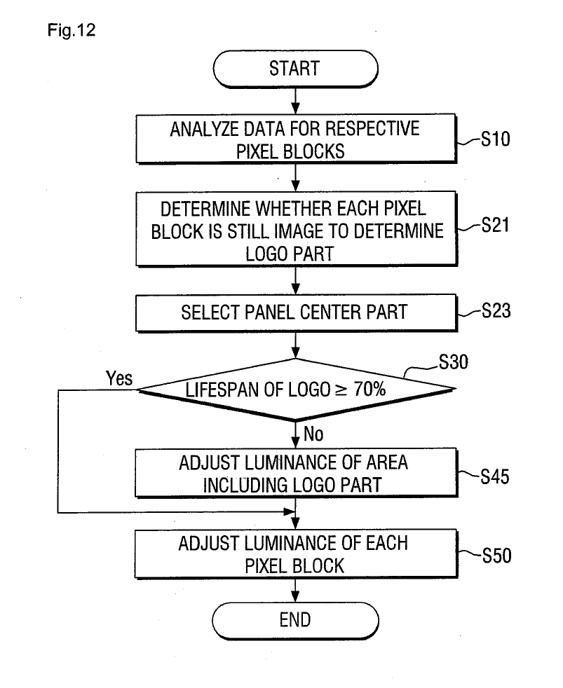

FIG. 12 is a flowchart illustrating a method of driving a display device according to another embodiment of the present invention.

Referring to FIG. 12, the method of driving the display device according to the present embodiment may include an operation S10 of analyzing data for respective pixel blocks. For example, operation S10 may include measuring the size of the input image signal R, G, B which is applied for each pixel block and the accumulated sum of the amount of data used in the individual pixel blocks. Further, the block selection unit 23 may analyze the amount of data of individual pixel blocks which are provided by the lifespan calculation unit 21 so as to determine whether or not each pixel block is a still image or a moving image. In one embodiment, if the change rate of the amount data of individual pixel blocks is substantially constant, the block is a still image, and if the change rate is not constant, the block is a moving image. The block selection unit 23 may perform an operation S21 of determining whether or not each pixel block is a still image to determine a logo part of the display device. For example, operation S21 may include selecting the area having the largest amount of data as the logo part from among blocks which are determined as still images. Further, the block selection unit 23 may perform an operation S23 of selecting the area having the smallest amount of data as the panel center part from among blocks which are determined as moving images. Further, an operation S30 of comparing whether or not the lifespan of the logo part is greater than or equal to a reference value (e.g., 70%) may be included. For example, the operation S30 may determine whether or not the remaining lifespan rate of the first pixel block 110, which has been measured by the lifespan calculation unit 21, has been reduced by a rate (e.g., preset rate) (e.g., 30% or more). In one embodiment, when the remaining lifespan of the logo part has been reduced by the rate (e.g., the preset rate), the data adjustment unit 25 may further perform an operation S45 of adjusting the luminance of an area of the display device including the logo part. The data adjustment unit 25 may adjust the maximum luminance of the panel center part by the value which is obtained by adding the rate (e.g., the preset rate) to the remaining lifespan rate of the logo part. If the remaining lifespan of the first pixel block 110 has been reduced less than the rate (e.g., the preset rate), the data adjustment unit 25 may retain the maximum luminance of the second pixel block 120 without any adjustment. Finally, in order to reduce or prevent noticeability (or clear recognition) of the maximum luminance difference between the first pixel block 110 and the second pixel block 120, the data adjustment unit 25 may gradually reduce the luminance of the pixel block which is located between the first pixel block 110 and the second pixel block 120 (S50). The luminance difference between areas may be less noticeable (or may not be clearly recognized) by gradually reducing the maximum luminance of each pixel area from the second pixel area 134 including the second pixel block 120 to the first pixel area 131 including the first pixel block 110.

According to embodiments of the present invention, a display device capable of reducing a luminance difference between areas of a panel may be provided.

While certain embodiments of the present invention have been illustrated and described, it is understood by those of ordinary skill in the art that certain modifications and changes can be made to the described embodiments without departing from the spirit and scope of the present invention as defined by the following claims, and equivalents thereof.

What is claimed is:

1. A display device comprising:
a display panel comprising a plurality of pixels; and
a controller configured to adjust a data signal applied to each of the plurality of pixels,
wherein the plurality of pixels comprises a plurality of pixel blocks, and
wherein the controller is configured to calculate a remaining lifespan of each of the plurality of pixel blocks and to adjust a maximum luminance of pixels between a first pixel block and a second pixel block based on a remaining lifespan of the first pixel block, by selecting the first pixel block and the second pixel block based on the remaining lifespan of each of the pixel blocks.

2. The display device of claim 1, wherein the first pixel block has a shortest remaining lifespan among the pixel blocks, and the second pixel block has a longest remaining lifespan among the pixel blocks.

3. The display device of claim 2, wherein the display panel comprises:
a first pixel area including the first pixel block; and
a second pixel area including the second pixel block,
wherein the respective maximum luminances of the pixel blocks in the first pixel area are substantially the same, and the respective maximum luminances of the pixel blocks in the second pixel area are substantially the same.

4. The display device of claim 3, wherein the maximum luminance of each of the pixel blocks increases at substantially the same rate from the first pixel area to the second pixel area on the basis of the remaining lifespan of the first pixel block.

5. The display device of claim 4, wherein, when the remaining lifespan of the first pixel block becomes shorter than a reference lifespan, the maximum luminance of the second pixel area is reduced by a difference between the rate of the remaining lifespan of the first pixel block and the rate of the reference lifespan.

6. The display device of claim 5, wherein the maximum luminance of each of the pixel blocks between the first pixel area and the second pixel area is reduced by a difference between the rate of the remaining lifespan of the first pixel block and the rate of the reference lifespan.

7. The display device of claim 2, wherein the remaining lifespan is measured based on accumulation of an amount of data by each of the pixel blocks.

8. The display device of claim 1, wherein the controller comprises:
a lifespan calculator configured to measure a lifespan of each pixel block;
a block selector configured to select the first pixel block having a shortest remaining lifespan among the pixel blocks and the second pixel block having a longest remaining lifespan among the pixel blocks; and
a data adjuster configured to adjust the maximum luminances of the first pixel block, the second pixel block, and each pixel block between the first pixel block and the second pixel block.

9. The display device of claim 8, wherein the data adjuster is configured to adjust a data signal applied to each pixel block between the first pixel block and the second pixel block so that the maximum luminance of each of the pixel blocks increases at substantially the same rate from the first pixel block to the second pixel block on the basis of the remaining lifespan of the first pixel block.

10. The display device of claim 8, wherein the data adjuster further comprises an average luminance calculator and the average luminance calculator is configured to measure the average luminance of each of the pixel blocks.

11. A display device comprising:
a display panel comprising a plurality of pixels; and
a controller configured to adjust a data signal applied to each of the plurality of pixels,
wherein the plurality of pixels comprises a plurality of pixel blocks, and
wherein the controller is configured to analyze the data signal applied to each of the pixel blocks so as to select a logo part and a central part, and is configured to adjust a maximum luminance of pixels between the logo part and the central part on the basis of a remaining lifespan of the logo part.

12. The display device of claim 11, wherein the logo part has a substantially constant change rate of an amount of data of the data signal applied to each of the pixel blocks and has a shortest remaining lifespan, and the central part has a non-constant change rate of the amount of data of the data signal applied to each of the pixel blocks and has a longest remaining lifespan.

13. The display device of claim 12, wherein the display panel comprises:
a first pixel area comprising the logo part; and
a second pixel area comprising the central part,
wherein respective maximum luminances of the pixel blocks in the first pixel area are substantially the same, and the respective maximum luminances of the pixel blocks in the second pixel area are substantially the same.

14. The display device of claim 13, wherein the maximum luminance of each of the pixel blocks increases at substantially the same rate from the first pixel area to the second pixel area on the basis of the remaining lifespan of the logo part.

15. The display device of claim 14, wherein the maximum luminance of each of the pixel blocks between the first pixel area and the second pixel area is reduced by a difference between the rate of the remaining lifespan of the logo part and a reference lifespan.

16. A method of driving a display device, the method comprising:
determining a remaining lifespan of each of a plurality of pixel blocks by analyzing an amount of data of an image signal applied to the plurality of pixel blocks;
selecting a first pixel block and a second pixel block from among the plurality of pixel blocks based on the determined remaining lifespan of each of the pixel blocks; and
adjusting a maximum luminance of a pixel block between the first pixel block and the second pixel block on the basis of the remaining lifespan of the first pixel block.

17. The method of claim 16, wherein the first pixel block has a shortest remaining lifespan among the pixel blocks, and the second pixel block has a longest remaining lifespan among the pixel blocks.

18. The method of claim 17, further comprising:
comparing the remaining lifespan of the first pixel block with a reference lifespan.

19. The method of claim 18, further comprising:
not adjusting the maximum luminance of the second pixel block when the remaining lifespan of the first pixel block is the reference lifespan or larger; and
adjusting the maximum luminance of the second pixel block when the remaining lifespan of the first pixel block is less than the reference lifespan.

20. The method of claim 16, wherein the first pixel block has a substantially constant change rate of the amount of data of a data signal applied to each of the pixel blocks and has a shortest remaining lifespan, and the second pixel block has a non-constant change rate of the amount of data of a data signal applied to each of the pixel blocks and has a longest remaining lifespan.
